(19) United States
(12) Patent Application Publication
(10) Pub. No.: US 2009/0005093 A1
(43) Pub. Date: Jan. 1, 2009

(54) SYSTEM AND METHOD FOR ACQUIRING BASE STATION SYNCHRONIZATION IN A COMMUNICATION SYSTEM

(75) Inventors: Byoung-Ha Yi, Seoul (KR); Ki-Young Han, Yongin-si (KR); In-Seok Hwang, Seoul (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/127,980

(22) Filed: May 28, 2008

(30) Foreign Application Priority Data
Jun. 26, 2007 (KR) 2007-63345

(51) Int. Cl. H04B 7/00

(52) U.S. Cl. 455/502

(57) ABSTRACT

A system and method for acquiring BS synchronization in a communication system are provided. In the system and method, a first BS acquires synchronization and transmits a frame to at least a second of the one or more neighbor BSs according to the synchronization, a second BS being the at least one neighbor BS estimates its first uplink frame synchronization time using a first arrival time of a downlink frame in the frame and transmits a first message at the first uplink frame synchronization time to the first BS, the first BS calculates a synchronization time difference by comparing a second arrival time of the first message with its uplink frame synchronization time and transmits a second message including the synchronization time difference to the second BS, and the second BS estimates a synchronization time using the synchronization time difference, acquires synchronization to the first BS, and transmits a frame generated with the same timing as the first BS.

### PRIORITY

This application claims the benefit under 35 U.S.C. §119(a) of a Korean patent application filed in the Korean Intellectual Property Office on Jun. 26, 2007 and assigned Serial No. 2007-63345, the entire disclosure of which is hereby incorporated by reference.

### BACKGROUND OF THE INVENTION

1. Field of the Invention

The present invention relates to a communication system. More particularly, the present invention relates to a system and method for acquiring synchronization by a Base Station (BS) in a communication system.

2. Description of the Related Art

Future-generation communication systems are under development to provide services capable of high-speed, large-data transmission and reception to Mobile Stations (MSs). An example of the future-generation communication systems is an Institute of Electrical and Electronics Engineers (IEEE) 802.16 system.

The IEEE 802.16 communication system uses Orthogonal Frequency Division Multiplexing (OFDM) that offers the benefits of Inter-Symbol Interference (ISI) cancellation through a simple equalizer, robustness against noise, and high frequency use efficiency. OFDM can be implemented in two ways, namely Frequency Division Duplex (FDD) and Time Division Duplex (TDD). In FDD, DownLink (DL) communication channels are distinguished from UpLink (UL) communication channels by dividing an entire frequency band along the frequency axis, while in TDD, an entire frequency band is shared between DL communication channels and UL communication channels in time division.

When time is not synchronized between adjacent BSs in a TDD-OFDM communication system, a DL frame overlaps with a UL frame. The resulting increase in mutual interference degrades the communication quality of MSs. To avert this problem, the TDD-OFDM communication system employs Global Positioning System (GPS)-based synchronization acquisition for synchronization between BSs.

To be more specific about the GPS-based synchronization acquisition scheme, a BS which is located so as to be capable of receiving a GPS signal and is equipped with a GPS receiver, receives the GPS signal directly and acquires BS synchronization using the GPS signal. In order to receive GPS signals from a satellite, the GPS receiver includes a GPS antenna and a GPS synchronizer. On the other hand, a BS that includes a GPS synchronizer, which is located so as not to be capable of receiving a GPS signal, may operate with a GPS antenna that is positioned where a GPS signal can be received. The GPS antenna is connected to the GPS synchronizer by a coaxial cable, to thereby acquire BS synchronization by receiving a GPS signal by the cable.

According to the above-described GPS-based synchronization acquisition scheme, the use of a coaxial cable to connect a GPS antenna to a BS increases the installation cost of the BS.

Also, every BS would need to be provided with a GPS synchronizer, and a Double-Oven Controlled Crystal Oscillator (DOCXO) for holdover time, which adds to the installation cost of the BS.

Accordingly, there exists a need for a technique for acquiring BS synchronization with a reduced BS installation cost.

### SUMMARY OF THE INVENTION

An aspect of the present invention is to address at least the problems and/or disadvantages and to provide at least the advantages described below. Accordingly, an aspect of the present invention is to provide a system and method for acquiring synchronization by a BS in a communication system.

Another aspect of the present invention is to provide a system and method for acquiring synchronization by a BS with a reduced BS installation cost.

In accordance with the present invention, a method for acquiring BS synchronization in a communication system is provided. The method includes a first BS acquiring synchronization and transmitting a frame generated based on the acquired synchronization to at least a second BS of one or more neighbor BSs, the second BS estimating a first uplink frame synchronization time of the second BS using a first arrival time of a downlink frame included in the frame and transmitting a first message at the first uplink frame synchronization time to the first BS, the first BS calculating a synchronization time difference by comparing a second arrival time of the first message with an uplink frame synchronization time of the first BS and transmits a second message including the synchronization time difference to the second BS, and the second BS estimating a synchronization time using the synchronization time difference, acquiring synchronization to the first BS, and transmitting a frame generated with the same timing as the first BS.

In accordance with another aspect of the present invention, a system for acquiring BS synchronization in a communication system is provided. The system includes a first BS for acquiring synchronization, for transmitting a frame generated based on the acquired synchronization to at least a second BS of one or more neighbor BSs, for, upon receipt of a first message from the second BS, calculating a synchronization time difference by comparing a second arrival time of the first message with an uplink frame synchronization time of the first BS, and for transmitting a second message including the synchronization time difference to the second BS, and the second BS for, upon receipt of a downlink frame included in the frame, estimating a first uplink frame synchronization time of the second BS using a first arrival time of the downlink frame, for transmitting the first message at the first uplink frame synchronization time to the first BS, for estimating a synchronization time using the synchronization time difference, for acquiring synchronization to the first BS, and for transmitting a frame generated with the same timing as the first BS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a configuration of a communication system according to an exemplary embodiment of the present invention;

FIG. 2 illustrates time charts of DL frames and UL frames in a communication system according to an exemplary embodiment of the present invention;

FIG. 3 is a flowchart illustrating an operation for acquiring synchronization between BSs in a communication system according to an exemplary embodiment of the present invention;

FIG. 4 is a flowchart illustrating an operation for transmitting a synchronization time difference to a BS without a GPS receiver by a BS with a GPS receiver, for synchronization acquisition in a communication system according to an exemplary embodiment of the present invention; and

FIG. 5 is a flowchart illustrating an operation for receiving a synchronization time difference from a BS with a GPS receiver and acquiring synchronization by a BS without a GPS receiver in a communication system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a system and method for acquiring synchronization by a BS in a communication system.

While the synchronization system and method of the illustrated exemplary embodiments of the present invention are applicable to any communication system, they may preferably be implemented in an IEEE 802.16 communication system.

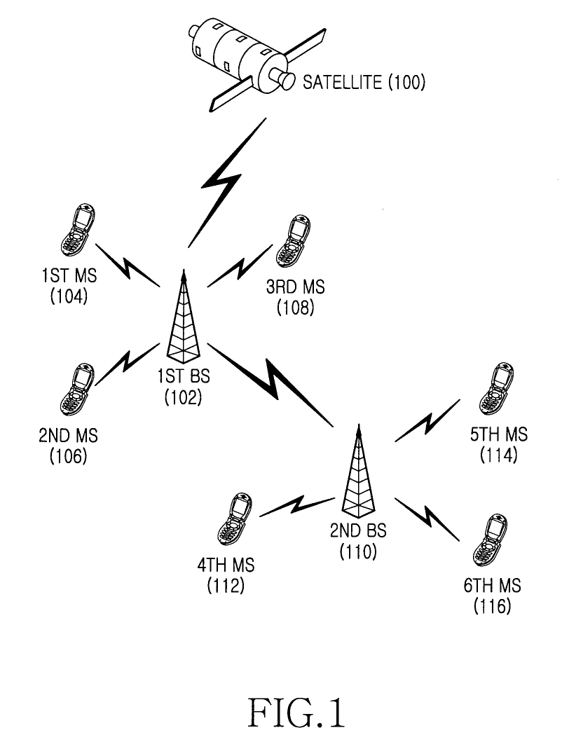

FIG. 1 illustrates a configuration of a communication system according to an exemplary embodiment of the present invention.

Referring to FIG. 1, the communication system includes a satellite 100, a first BS 102 for acquiring synchronization by receiving a GPS signal from the satellite 100, first, second and third MSs 104, 106 and 108 within a cell of the first BS 102, a second BS 110 for acquiring synchronization to the first BS 102, and fourth, fifth and sixth MSs 112, 114 and 116 within a cell of the second BS 110.

In operation, the satellite 100 transmits a GPS signal to the first BS 102, for use in BS synchronization. The GPS signal may include synchronization acquisition information by which a BS can acquire synchronization.

The first BS 102, which has a GPS receiver, receives the GPS signal from the satellite 100 through the GPS receiver, detects the synchronization acquisition information by analyzing the received GPS signal, and acquires frame synchronization based on the synchronization acquisition information. The first BS 102 generates a frame according to the frame synchronization and transmits the frame to the first, second and third MSs 104, 106 and 108 and the second BS 110. The frame includes a DL frame and a UL frame, and a preamble signal can be allocated in a first OFDM symbol of the DL frame.

Upon receipt of a first message in response to the transmitted frame from the second BS 110, the first BS 102 measures the arrival time of the first message. The first message can be a Ranging-Request (RNG-REQ) message. The first BS 102 determines the arrival time of the first message to be a synchronization time at which the second BS 110 generates a UL frame (referred to as a second UL frame synchronization time of the second BS 110).

The first BS 102 calculates the difference between a synchronization time of its UL frame with the second UL frame synchronization time of the second BS 110. The UL frame synchronization time of the first BS 102 refers to the synchronization time of the UL frame of the first BS 102 that is acquired from the GPS signal. The first BS 102 then generates a second message including the synchronization time difference and transmits the second message to the second BS 110. The second message can be any message that can be transmitted from the first BS 102 to the second BS 110. Preferably, the second message can be a Ranging-Response (RNG-RSP) message.

Upon receipt of the first symbol of the DL frame from the first BS 102, the second BS 110, which is not equipped with a GPS receiver, measures the arrival time of the DL frame. For example, if a preamble signal is carried in the first symbol of the DL frame, the second BS 110 measures the arrival time of the preamble signal.

The second BS 110 determines the arrival time of the DL frame to be a synchronization time at which the second BS 110 will transmit a DL frame (referred to as the DL frame synchronization time of the second BS 110) and calculates a first UL frame synchronization time of the second BS 110 based on its DL frame synchronization time. Then the second BS 110 generates the first message and transmits the first message to the first BS 102 at its first UL frame synchronization time. The first message can be any message that can be transmitted from the second BS 110 to the first BS 102. The first message is preferably the RNG-REQ message.

Upon receipt of the second message in response to the first message from the first BS 102, the second BS 110 detects the synchronization time difference by analyzing the second message. Then the second BS 110 calculates a new DL frame synchronization time of the second BS 110 using the DL frame synchronization time of the second BS 110 and the synchronization time difference, acquires frame synchronization based on the new DL frame synchronization time of the second BS 110, generates a frame, and transmits the frame to the fourth, fifth and sixth MSs 112, 114 and 116 based on the frame synchronization.

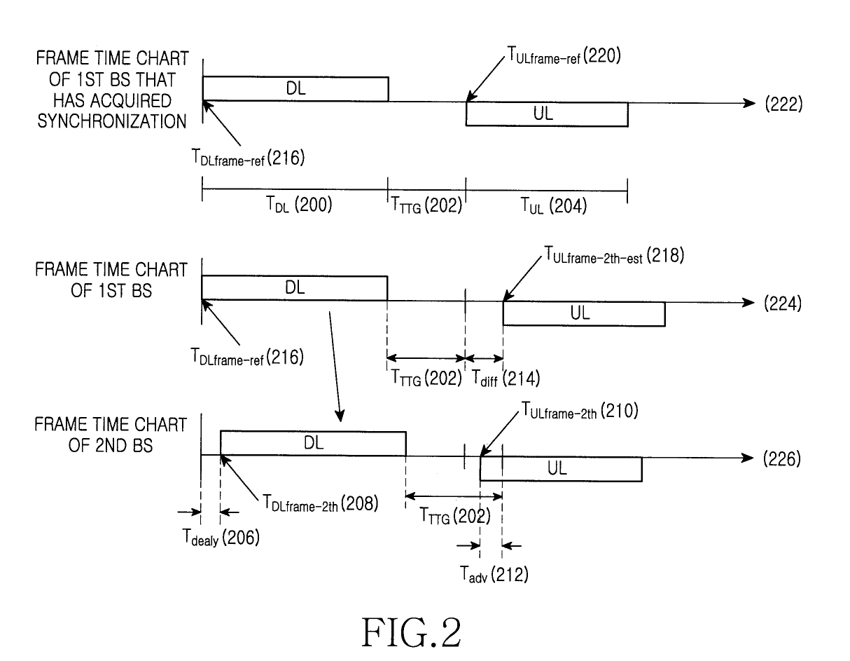

FIG. 2 illustrates time charts of DL frames and UL frames in a communication system according to an exemplary embodiment of the present invention.

Referring to FIG. 2, reference numeral 222 denotes a frame time chart of the first BS 102 that has acquired frame synchronization from a GPS signal. Reference numeral 224 denotes a frame time chart of the first BS 102, taking into account a UL frame synchronization time of the second BS 110. Reference numeral 226 denotes a frame time chart of the second BS 110, taking into account a DL frame synchronization time of the first BS 102.

Upon acquisition of synchronization from the GPS signal, the first BS 102 transmits a DL frame to the second BS 110 and the MSs 104, 106 and 108 during a transmission interval of the DL frame 200, T_{DL} starting from a DL frame synchronization time 216 of the first BS 102, T_{DLframe-ref}. After a time 202 T_{TTG}, the first BS 102 receives a UL frame from the MSs 104, 106 and 108 during a reception interval 204 of the UL frame, T_{UL} starting from a UL frame synchronization time 220 of the first BS 102, T_{ULframe-ref}. T_{TTG} is a preset interval that distinguishes a DL frame from a UL frame.

According to an exemplary embodiment of the present invention, for synchronization between the first BS 102 and the second BS 110, the first BS 102 transmits the DL frame to the second BS 110 at T_{DLframe-ref} as indicated in the time chart 224.

As illustrated in the time chart 226, the second BS 110 receives the DL frame after a real propagation delay 206 T_{delay} later than T_{DLframe-ref} and measures the arrival time of the first symbol of the DL frame. Then the second BS 110 determines the arrival time of the first symbol to be its DL frame synchronization time 208, T_{DLframe-2th}. The second BS 110 calculates its first UL frame synchronization time T_{ULframe-2th} by summing T_{DLframe-2th}, T_{DL}, and T_{TTG} and subtracting a preset predicted propagation delay 212, T_{adv}, between the first and second BSs 102 and 110 from the sum, expressed as

T_{ULframe-2th}=T_{DLframe-2th}+T_{DL}+T_{TTG}−T_{adv} (1)

where T_{ULframe-2th} denotes the first UL frame synchronization time of the second BS 110, T_{DLframe-2th} denotes the DL frame synchronization time of the second BS 110, T_{DL} denotes the transmission interval of the DL frame, T_{TTG} denotes the interval that distinguishes a DL frame from a UL frame, and T_{adv} denotes the predicted propagation delay between the first BS 102 and the second BS 110.

The second BS 110 then generates a first message and transmits the first message to the first BS 102 at time 210, T_{ULframe-2th}.

The first BS 102 receives the first message T_{delay} later and measures the arrival time of the first message. The first BS 102 estimates the arrival time of the first message to be a second UL frame synchronization time 218 of the second BS 110, T_{ULframe-2th-est} and calculates a synchronization time difference 214, T_{diff} by comparing T_{ULframe-ref} with T_{ULframe-2th-est} by

T_{diff}=T_{ULframe-2th-est}−T_{ULframe-ref}=2T_{delay}−T_{adv} (2)

where T_{diff} denotes the synchronization time difference, T_{ULframe-2th-est} denotes the second UL frame synchronization time of the second BS 110 as estimated by the first BS 102, T_{ULframe-ref} denotes the UL frame synchronization time of the first BS 102, T_{delay} denotes the real propagation delay, and T_{adv} denotes the predicted propagation delay between the first BS 102 and the second BS 110.

The first BS 102 generates a second message including T_{diff} and transmits the second message to the second BS 110.

Upon receipt of the second message, the second BS 110 detects T_{diff} by analyzing the second message and calculates T_{delay} using T_{diff}. To synchronize itself to the first BS 102, the second BS 110 calculates a synchronization time by subtracting T_{delay} from T_{DLframe-2th} and acquires synchronization to the first BS 102 based on the synchronization time. The synchronization time refers to the DL frame synchronization time of the first BS 102 by which the second BS 110 is synchronized to the first BS 102. The synchronization time is computed by

$$sync = {T}_{DLframe - 2 th} - {T}_{delay} = {T}_{DLframe - 2 th} - \frac{{T}_{diff} + {T}_{adv}}{2} \qquad ( 3 )$$

where sync denotes the synchronization time, T_{DLframe-2th} denotes the DL frame synchronization time of the second BS 110, T_{delay} denotes the real propagation delay, T_{diff} denotes the synchronization time difference, and T_{adv} denotes the predicted propagation delay between the first BS 102 and the second BS 110.

While the second BS 110 acquires synchronization taking into account T_{adv} in the illustrated case of FIG. 2, the synchronization can be acquired without T_{adv}. In this case, the second BS 110 can calculate T_{ULframe-2th} by

T_{ULframe-2th}=T_{DLframe-2th}+T_{DL}+T_{TTG} (4)

where T_{ULframe-2th} denotes the first UL frame synchronization time of the second BS 110, T_{DLframe-2th} denotes the DL frame synchronization time of the second BS 110, T_{DL} denotes the transmission interval of the DL frame, and T_{TTG} denotes the interval between the UL frame and the DL frame.

The first BS 102 calculates T_{diff} by

T_{diff}=T_{ULframe-2th-est}−T_{ULframe-ref}=2T_{delay} (5)

where T_{diff} denotes the synchronization time difference, T_{ULframe-ref} denotes the UL frame synchronization time of the first BS 102, T_{ULframe-2th-est} denotes the second UL frame synchronization time of the second BS 110 as estimated by the first BS 102, and T_{delay} denotes the real propagation delay.

Thus, the second BS 110 computes sync by

$$sync = {T}_{DLframe - 2 th} - {T}_{delay} = {T}_{DLframe - 2 th} - \frac{{T}_{diff}}{2} \qquad ( 6 )$$

where sync denotes the synchronization time, T_{DLframe-2th} denotes the DL frame synchronization time of the second BS 110, T_{delay} denotes the real propagation delay, and T_{diff} denotes the synchronization time difference.

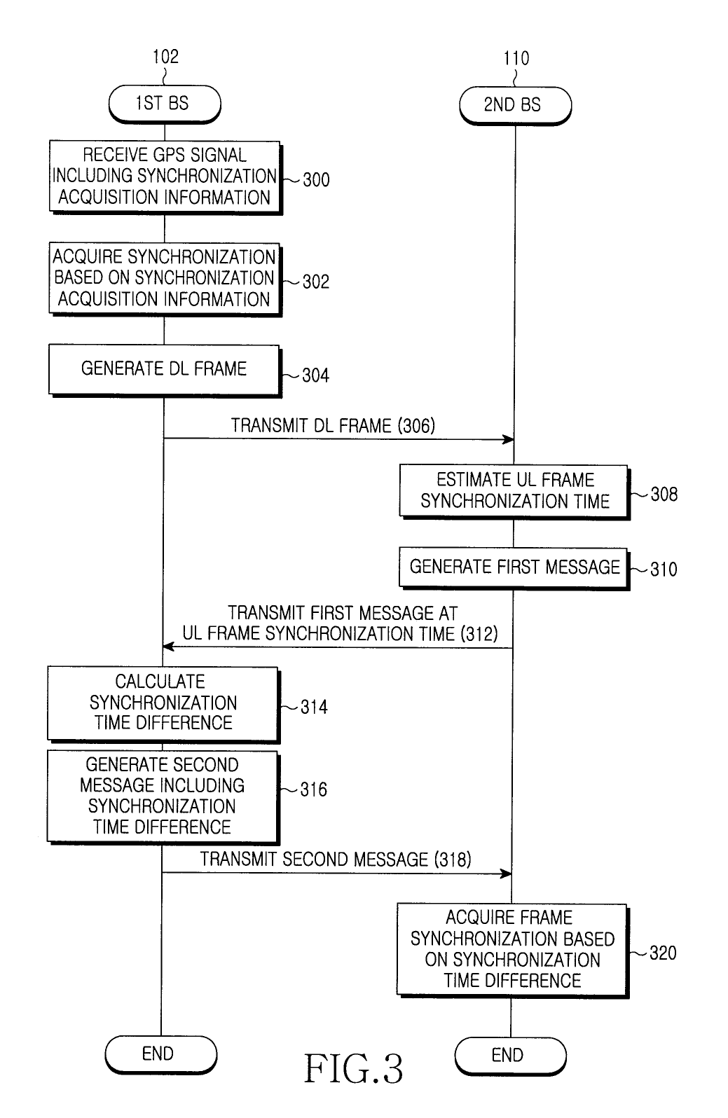

FIG. 3 is a flowchart illustrating an operation for acquiring synchronization between BSs in a communication system according to an exemplary embodiment of the present invention.

For better understanding of an exemplary embodiment of the present invention, it is assumed that the first BS 102 has a GPS receiver and the second BS 110 does not have one.

Referring to FIG. 3, the first BS 102 periodically receives a GPS signal including synchronization acquisition information from the satellite 100 in step 300. In step 302, the first BS 102 detects synchronization acquisition information by analyzing the GPS signal and acquires synchronization based on the synchronization acquisition information. The first BS 102 generates a frame in step 304 and transmits the frame to the MSs 104, 106 and 108 and the second BS 110 in step 306. The frame is divided into a DL frame and a UL frame.

Upon receipt of a first symbol of the DL frame from the first BS 102, the second BS 110 measures the arrival time of the first symbol and estimates the arrival time of the first symbol to be its DL frame synchronization time in step 308. For instance, if the first symbol of the DL frame carries a preamble signal, the second BS 110 can estimate the arrival time of the preamble signal from the first BS 102 to be its DL frame synchronization time.

After estimating its first UL frame synchronization time using the DL frame synchronization time, the second BS 110 proceeds to step 310. For example, the second BS 110 can estimate the first UL frame synchronization time by equation (1) or equation (4).

The second BS 110 generates a first message in step 310 and transmits the first message to the first BS 102 at the first UL frame synchronization time in step 312.

In step 314, the first BS 102 measures the arrival time of the first message and estimates the arrival time of the first message to be a second UL frame synchronization time of the second BS 110. Then the first BS 102 calculates a synchronization time difference by comparing the second UL synchronization time of the second BS 110 with its UL frame synchronization time acquired by use of a GPS signal. For example, the first BS 102 calculates the synchronization time difference by equation (2) or equation (5).

The first BS 102 generates a second message including the synchronization time difference in step 316 and transmits the second message to the second BS 110 in step 318.

Upon receipt of the second message, the second BS 110 detects the synchronization time difference by analyzing the second message, estimates a synchronization time based on the synchronization time difference, and acquires synchronization to the first BS 102 based on the synchronization time in step 320. Then the second BS 110 generates a frame with the same timing as that of the first BS 102 and transmits the frame to the MSs 112, 114 and 116. For example, the second BS 110 can estimate the synchronization time by equation (3) or equation (6).

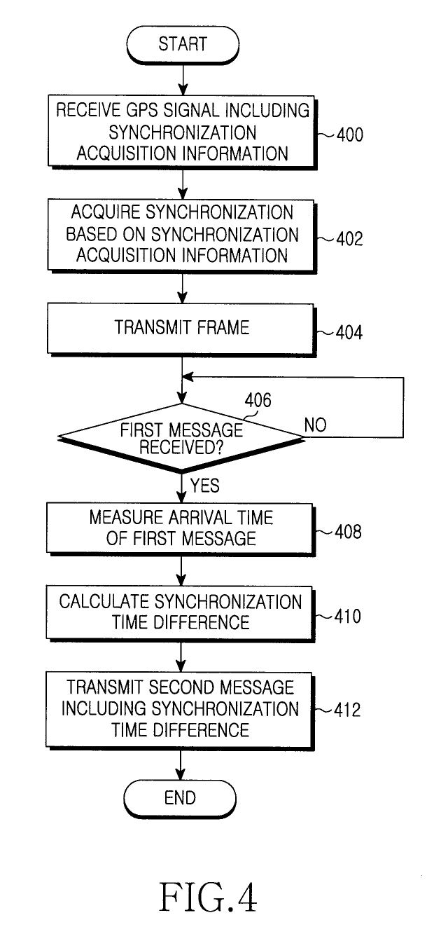

FIG. 4 is a flowchart illustrating an operation for transmitting a synchronization time difference to a BS without a GPS receiver by a BS with a GPS receiver, for synchronization acquisition in a communication system according to an exemplary embodiment of the present invention.

For better understanding of an exemplary embodiment of the present invention, it is assumed that the BS with a GPS receiver is the first BS 102 and the BS without a GPS receiver is the second BS 110.

Referring to FIG. 4, the first BS 102 receives a GPS signal including synchronization acquisition information from the satellite 100 in step 400. In step 402, the first BS 102 detects synchronization acquisition information by analyzing the GPS signal and acquires synchronization based on the synchronization acquisition information. The first BS 102 generates a DL frame and transmits it to the second BS based on the acquired synchronization in step 404.

In step 406, the first BS 102 monitors whether a first message has been received from the second BS 110. Upon receipt of the first message, the first BS 102 proceeds to step 408 and otherwise, it repeats step 406.

In step 408, the first BS 102 measures the arrival time of the first message and estimates the arrival time of the first message to be a second UL frame synchronization time of the second BS 110.

Then the first BS 102 calculates a synchronization time difference by comparing the second UL synchronization time of the second BS 110 with its UL frame synchronization time in step 410. For example, the first BS 102 calculates the synchronization time difference by equation (2) or equation (5).

The first BS 102 generates a second message including the synchronization time difference and transmits the second message to the second BS 110 in step 412.

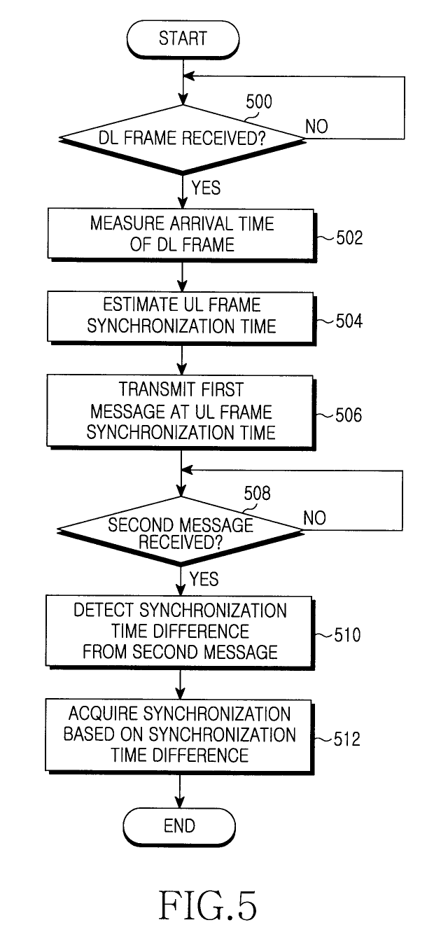

FIG. 5 is a flowchart illustrating an operation for receiving a synchronization time difference from a BS with a GPS receiver and acquiring synchronization by a BS without a GPS receiver in a communication system according to an exemplary embodiment of the present invention.

For a better understanding of an exemplary embodiment of the present invention, it is assumed that the BS with a GPS receiver is the first BS 102 and the BS without a GPS receiver is the second BS 110.

Referring to FIG. 5, upon receipt of a first symbol of a DL frame from the first BS 102 in step 500, the second BS 110 proceeds to step 502. Otherwise, the second BS 110 repeats step 500. For example, if the first symbol of the DL frame carries a preamble signal, upon receipt of the preamble signal from the first BS 102, the second BS 110 proceeds to step 502.

In step 502, the second BS 110 measures the arrival time of the first symbol of the DL frame and estimates the arrival time of the first symbol to be its DL frame synchronization time. The second BS 110 estimates its first UL frame synchronization time using the DL frame synchronization time in step 504. For example, the second BS 110 can estimate the first UL frame synchronization time by equation (1) or equation (4).

The second BS 110 generates a first message and transmits the first message to the first BS 102 at the first UL frame synchronization time in step 506. Upon receipt of a second message including a synchronization time difference from the first BS 102 in step 508, the second BS 110 goes to step 510. Otherwise, the second BS 110 repeats step 508.

In step 510, the second BS 110 detects the synchronization time difference by analyzing the second message. The second BS 110 estimates a synchronization time based on the synchronization time difference, acquires synchronization to the first BS 102, and transmits a frame with the same timing as that of the first BS 102 in step 512. For example, the second BS 110 can estimate the synchronization time by equation (3) or equation (6).

As is apparent from the above description, exemplary embodiments of the present invention advantageously enables a BS without a GPS receiver to acquire synchronization wirelessly in a communication system.

While the invention has been shown and described with reference to certain exemplary embodiments thereof, they are merely exemplary applications. For example, while it has been described that synchronization is acquired between a BS with a GPS receiver and a BS without a GPS receiver in the exemplary embodiments of the present invention, the synchronization acquisition can take place among a BS with a GPS receiver and a plurality of BSs without GPS receivers. Also, although it has been assumed that the first message and the second message are an RNG-REQ message and an RNG-RSP message, respectively, other messages are available as the first and second messages. Thus, it will be understood by those skilled in the art that various changes in form and details may be made therein without departing from the spirit and scope of the invention as defined by the appended claims and their equivalents.

What is claimed is:

1. A method for acquiring Base Station (BS) synchronization in a communication system, comprising:
acquiring synchronization by a first BS;
transmitting a frame, generated based on the acquired synchronization, to at least a second BS of one or more neighbor BSs by the first BS;
estimating a first uplink frame synchronization time of the second BS using a first arrival time of a downlink frame included in the frame by the second BS;
transmitting a first message at the first uplink frame synchronization time to the first BS by the second BS;
calculating a synchronization time difference by comparing a second arrival time of the first message with an uplink frame synchronization time of the first BS by the first BS;
transmitting a second message including the synchronization time difference to the second BS by the first BS;
estimating a synchronization time using the synchronization time difference, acquiring synchronization to the first BS by the second BS; and
transmitting a frame generated with the same timing as the first BS by the second BS.

2. The method of claim 1, wherein the estimating of the first uplink frame synchronization time of the second BS comprises estimating the first uplink frame synchronization time of the second BS using a preset predicted propagation delay between the first BS and the second BS by the equation,
T_{ULframe-2th}=T_{DLframe-2th}+T_{DL}+T_{TTG}−T_{adv}
where T_{ULframe-2th} denotes the first uplink frame synchronization time of the second BS, T_{DLframe-2th} denotes the first arrival time, T_{DL} denotes a transmission interval of the downlink frame, T_{TTG} denotes an interval that distinguishes a downlink frame from an uplink frame, and T_{adv} denotes the predicted propagation delay.

3. The method of claim 2, wherein the calculating of the synchronization time difference comprises calculating the synchronization time difference using the predicted propagation delay by the equation,
T_{diff}=T_{ULframe-2th-est}−T_{ULframe-ref}=2T_{delay}−T_{adv}
where T_{diff} denotes the synchronization time difference, T_{ULframe-2th-est} denotes the second arrival time, T_{ULframe-ref} denotes the uplink frame synchronization time of the first BS, T_{delay} denotes a real propagation delay, and T_{adv} denotes the predicted propagation delay.

4. The method of claim 3, wherein the estimating of the synchronization time comprises estimating the synchronization time, taking into account the predicted propagation delay by the equation,
$$sync = {T}_{DLframe - 2 th} - {T}_{delay} = {T}_{DLframe - 2 th} - \frac{{T}_{diff} + {T}_{adv}}{2}$$
where sync denotes the synchronization time, T_{DLframe-2th} denotes the first arrival time, T_{delay} denotes the real propagation delay, T_{diff} denotes the synchronization time difference, and T_{adv} denotes the predicted propagation delay.

5. The method of claim 1, wherein the estimating of the first uplink frame synchronization time of a second BS comprises estimating the first uplink frame synchronization time of the second BS by the equation,
T_{ULframe-2th}=T_{DLframe-2th}+T_{DL}+T_{TTG}
where T_{ULframe-2th} denotes the first uplink frame synchronization time of the second BS, T_{DLframe-2th} denotes the first arrival time, T_{DL} denotes a transmission interval of the downlink frame, and T_{TTG} denotes an interval that distinguishes a downlink frame from an uplink frame.

6. The method of claim 5, wherein the calculating of the synchronization time difference comprises calculating the synchronization time difference by the equation,
T_{diff}=T_{ULframe-2th-est}−T_{ULframe-ref}=2T_{delay}
where T_{diff} denotes the synchronization time difference, T_{ULframe-2th-est} denotes the second arrival time, T_{ULframe-ref} denotes the uplink frame synchronization time of the first BS, and T_{delay} denotes a real propagation delay.

7. The method of claim 6, wherein the estimating of the synchronization time comprises estimating the synchronization time by the equation,
$$sync = {T}_{DLframe - 2 th} - {T}_{delay} = {T}_{DLframe - 2 th} - \frac{{T}_{diff}}{2}$$
where sync denotes the synchronization time, T_{DLframe-2th} denotes the first arrival time, T_{delay} denotes the real propagation delay, and T_{diff} denotes the synchronization time difference.

8. The method of claim 1, wherein the first message comprises a ranging request message.

9. The method of claim 1, wherein the second message comprises a ranging response message.

10. The method of claim 1, wherein the acquiring of the synchronization by a first BS comprises receiving a Global Positioning System (GPS) signal.

11. A system for acquiring Base Station (BS) synchronization in a communication system, comprising:
a first BS for acquiring synchronization, for transmitting a frame generated based on the acquired synchronization to at least a second BS of one or more neighbor BSs, upon receipt of a first message from the second BS, for calculating a synchronization time difference by comparing a second arrival time of the first message with an uplink frame synchronization time of the first BS, and for transmitting a second message including the synchronization time difference to the second BS; and
the second BS for, upon receipt of a downlink frame included in the frame, estimating a first uplink frame synchronization time of the second BS using a first arrival time of the downlink frame, for transmitting the first message at the first uplink frame synchronization time to the first BS, for estimating a synchronization time using the synchronization time difference, for acquiring synchronization to the first BS, and for transmitting a frame generated with the same timing as the first BS.

12. The system of claim 11, wherein the second BS estimates the first uplink frame synchronization time of the second BS using a preset predicted propagation delay between the first BS and the second BS by the equation,
T_{ULframe-2th}=T_{DLframe-2th}+T_{DL}+T_{TTG}−T_{adv}
where T_{ULframe-2th} denotes the first uplink frame synchronization time of the second BS, T_{DLframe-2th} denotes the first arrival time, T_{DL} denotes a transmission interval of the downlink frame, T_{TTG} denotes an interval that distinguishes a downlink frame from an uplink frame, and T_{adv} denotes the predicted propagation delay.

13. The system of claim 12, wherein the first BS calculates the synchronization time difference using the predicted propagation delay by the equation,
T_{diff}=T_{ULframe-2th-est}−T_{ULframe-ref}=2T_{delay}−T_{adv}
where T_{diff} denotes the synchronization time difference, T_{ULframe-2th-est} denotes the second arrival time, T_{ULframe-ref} denotes the uplink frame synchronization time of the first BS, T_{delay} denotes a real propagation delay, and T_{adv} denotes the predicted propagation delay.

14. The system of claim 13, wherein the second BS estimates the synchronization time taking into account the predicted propagation delay by the equation,
$$sync = {T}_{DLframe - 2 th} - {T}_{delay} = {T}_{DLframe - 2 th} - \frac{{T}_{diff} + {T}_{adv}}{2}$$
where sync denotes the synchronization time, T_{DLframe-2th} denotes the first arrival time, T_{delay} denotes the real propagation delay, T_{diff} denotes the synchronization time difference, and T_{adv} denotes the predicted propagation delay.

15. The system of claim 11, wherein the second BS estimates the first uplink frame synchronization time of the second BS by the equation,
T_{ULframe-2th}=T_{DLframe-2th}+T_{DL}+T_{TTG}
where T_{ULframe-2th} denotes the first uplink frame synchronization time of the second BS, T_{DLframe-2th} denotes the first arrival time, T_{DL} denotes a transmission interval of the downlink frame, and T_{TTG} denotes an interval that distinguishes a downlink frame from an uplink frame.

16. The system of claim 15, wherein the first BS calculates the synchronization time difference by the equation,
T_{diff}=T_{ULframe-2th-est}−T_{ULframe-ref}=2T_{delay}
where T_{diff} denotes the synchronization time difference, T_{ULframe-2th-est} denotes the second arrival time, T_{ULframe-ref} denotes the uplink frame synchronization time of the first BS, and T_{delay} denotes a real propagation delay.

17. The system of claim 16, wherein the second BS estimates the synchronization time by the equation,
$$sync = {T}_{DLframe - 2 th} - {T}_{delay} = {T}_{DLframe - 2 th} - \frac{{T}_{diff}}{2}$$
where sync denotes the synchronization time, T_{DLframe-2th} denotes the first arrival time, T_{delay} denotes the real propagation delay, and T_{diff} denotes the synchronization time difference.

18. The system of claim 11, wherein the first message comprises a ranging request message.

19. The system of claim 11, wherein the second message comprises a ranging response message.

20. The system of claim 11, wherein the first BS acquires synchronization by receiving a Global Positioning System (GPS) signal.
